(19) United States
(12) Patent Application Publication
(10) Pub. No.: US 2009/0216547 A1
(43) Pub. Date: Aug. 27, 2009

(54) METHOD, SYSTEM AND COMPUTER PROGRAM PRODUCT FOR PROVIDING REAL-TIME RECOMMENDATIONS

(75) Inventors: David J. Canora, Winter Garden, FL (US); David B. Gross, Clermont, FL (US); Robert David Grossman, Lake Mary, FL (US); Ernest L. Martin, Orlando, FL (US); Scott Rench, Orlando, FL (US)

Correspondence Address: DISNEY ENTERPRISES, INC.;C/O CANTOR COLBURN LLP, 20 Church Street, 22nd Floor, Hartford, CT, 06103, US

(73) Assignee: DISNEY ENTERPRISES, INC., Burbank, CA (US)

(21) Appl. No.: 12/036,176

(22) Filed: Feb. 22, 2008

(51) Int. Cl. G06Q 10/00

(52) U.S. Cl. 705/1

(57) ABSTRACT

A method, system and computer program product for providing real-time recommendations. The method includes accessing an itinerary corresponding to a guest of a venue, the venue having a plurality of attractions. The itinerary was created in response to one or both of preferences of the guest and historical data about the venue. Real-time data about the guest and/or real-time data about the venue are received. A real-time recommendation is created in response to the itinerary, to a current location of the guest, and to one or more of the real-time data about the guest and the real-time data about the venue. The real-time recommendation includes one or more suggested future activities for the guest. The one or more suggested future activities are communicated to the guest via a user device.

### BACKGROUND

1. Field of the Invention

Embodiments of the invention relate generally to providing activity recommendations to guests of a venue, and in particular to providing recommendations to a guest at a venue based on one or both of real-time data about the venue and real-time data about the guest.

2. Discussion of the Related Art

Typically, guests visiting a venue, such as an amusement park or museum, would like to tour the venue in an efficient manner. They may want to visit particular attractions (e.g., rides, shows, parades) and minimize the amount of time that they spend waiting in lines. Itineraries may be generated in advance by the guest or by a third party, based on the date and/or hours that the guest is planning to be at the venue and the activities at the venue that are of interest to the guest. Itineraries may be created using historical data such as typical crowd movement through the venue and the number of guests expected on a particular day. The guests may be asked in advance, or upon entering the venue, about their interest in specific activities or types of activities at the venue. In addition, guests may be asked about what activities, or types of activities, they would like to avoid, how much time they plan to spend at the venue, and their preferences for meals (types and times). An itinerary for the guest is then created which includes a planned route through the venue.

One problem with utilizing a fixed itinerary based on user preferences and historical data about the venue as described above is that the itinerary does not take into account the actual current conditions of the venue. For example, it does not take into account actual conditions which may occur, such as there being more guests than expected waiting to attend a particular activity, or current weather conditions such as extreme heat or rain, in which case a guest may prefer a different set of activities than those in the itinerary. In addition, a fixed itinerary is inflexible in that it does not take into account a current state of the guest. For example, the guest may be hungry and/or tired and may want to deviate from the planned itinerary.

In summary, the concept of the current technology is to generate a fixed itinerary based on guest preferences and historical data about the venue. This limits the usefulness of the itinerary because the itinerary cannot account for an actual current state of the venue. In addition, a fixed itinerary cannot be updated based on real-time changes in guest preferences.

### SUMMARY OF THE INVENTION

Embodiments of the invention include a method for providing real-time recommendations. The method includes accessing an itinerary corresponding to a guest of a venue, the venue having a plurality of attractions. The itinerary was created in response to one or both of preferences of the guest and historical data about the venue. Real-time data about the guest and/or real-time data about the venue are received. A real-time recommendation is created in response to the itinerary, to a current location of the guest, and to one or more of the real-time data about the guest and the real-time data about the venue. The real-time recommendation includes one or more suggested future activities for the guest. The one or more suggested future activities are communicated to the guest via a user device.

Other embodiments include a system for providing real-time recommendations. The system includes a computer processing unit and computer instructions executing on the computer processing unit for facilitating accessing an itinerary corresponding to a guest of a venue. The venue has a plurality of attractions and the itinerary is created in response to one or more of preferences of the guest and to historical data about the venue. Real-time data about the guest and/or real-time data about the venue are received. A real-time recommendation is created in response to the itinerary, to a current location of the guest, and to one or more of the real-time data about the guest and the real-time data about the venue. The real-time recommendation includes one or more suggested future activities for the guest. The one or more suggested future activities are communicated to the guest via a user device.

Further embodiments include a computer program product for providing real-time recommendations. The computer program product includes a computer-readable storage medium for storing instructions for executing a real-time recommendation service method. The method includes accessing an itinerary corresponding to a guest of a venue, the venue having a plurality of activities. The itinerary was created in response to one or both of preferences of the guest and historical data about the venue. Real-time data about the guest and/or real-time data about the venue are received. A real-time recommendation is created in response to the itinerary, to a current location of the guest, and to one or more of the real-time data about the guest and the real-time data about the venue. The real-time recommendation includes one or more suggested future activities for the guest. The one or more suggested future activities are communicated to the guest via a user device.

Still further embodiments include a device for creating a dynamic itinerary for a guest at a venue. The device includes one or more processes executing within the device and operable to access a preexisting itinerary. The device also includes one or more processes executing within the device and operable to access real-time data about the guest. The device further includes one or more processes executing within the device and operable to access real-time data about the venue. In addition, the device includes one or more processes executing within the device and operable to modify the preexisting itinerary to create the dynamic itinerary using the real-time data about the guest and the real-time data about the venue.

Still further embodiments include a crowd management system including a central system for collecting real-time information about a plurality of guests at a venue and real-time operations data about the venue. The system also includes processes operable to use the collected real-time information and the real-time operations data to generate real-time recommendations for future activities of two or more of the plurality of guests.

### BRIEF DESCRIPTION OF THE DRAWINGS

Further features, aspects and advantages of the apparatus and methods of the embodiments of the invention will become better understood with regard to the following description, appended claims, and accompanying drawings.

FIG. 1 is a block diagram of a real-time recommender system that may be implemented by an exemplary embodiment of the present invention;

FIG. 2 is a block diagram of a real-time recommender system that may be implemented by an exemplary embodiment of the present invention; and

FIG. 3 is a flowchart of an exemplary process for providing a real-time recommender service.

### DESCRIPTION OF EXEMPLARY EMBODIMENTS

Exemplary embodiments, as shown and described by the various figures and the accompanying text, provide a method, system and computer program product for providing real-time recommendations to guests of a venue (e.g., an amusement park). Exemplary embodiments of the present invention provide one or more suggested activities to a guest of a venue based on historical data combined with real-time data about the venue and/or the guest. The real-time recommendations include a list of one or more suggested future activities for the guest. The guest can passively and/or actively indicate what activities they have already done to influence future recommendations.

As used herein, the term “venue” refers to a scene or locale of any action or event, including, but not limited to: a theme park, a museum, a stadium, a park, a casino, a department store, a shopping mall, a zoo, a hotel, and a residential community. As used herein, the term “guest” refers to a person who is visiting the venue. As used herein, the term “attraction” refers to any point of interest in the venue. If the venue is a museum, for example, the attractions could include viewing particular pieces of art, viewing particular collections of art, eating at the museum cafeteria, viewing movies, etc. If the venue is an amusement park, the attractions could include amusement rides, parades, shows and restaurants.

The itinerary is created based on preferences indicated by the guest as well as historical data about the venue. In addition, the itinerary created for a particular guest may take into account an itinerary created for another guest in order to spread guests around the venue. As a particular example, an itinerary describes a model day for the guest. As used herein, the term “preferences of the guest” refers to information such as, but not limited to: attractions that the guest would like to visit, attractions that the guest has visited in the past and the guest response (e.g., liked, disliked) to those attractions, types of activities that guest has indicated a like or dislike of, special needs of the guest (e.g., wheelchair, limited eye sight, etc.) and/or any other information that can be used to create, update and/or maintain an itinerary. Preferences may be received from the guest via a user interface on a user device 104 and/or received in electronic format from a computer program or data storage device. As used herein, the term “historical data about the venue” refers to information representing how the venue is typically toured by the guests, the number of guests expected on particular dates and at particular times, typical wait times for various attractions, etc.

As used herein, the term “real-time data about the venue” refers to a current state of the venue, including, but not limited to: a current wait time at one or more of the attractions, a current status of whether particular attractions are open, wait times at particular attractions, number of tickets available for upcoming shows/events, show schedules, restaurant availability and wait times, and venue dynamics (e.g., attendance level, weather, etc.). As used herein, the term “real-time data about the guest” refers to a current state of the guest, including, but not limited to: a current geographic location of the guest, current preferences of the guest, and a current estimated energy level of the guest.

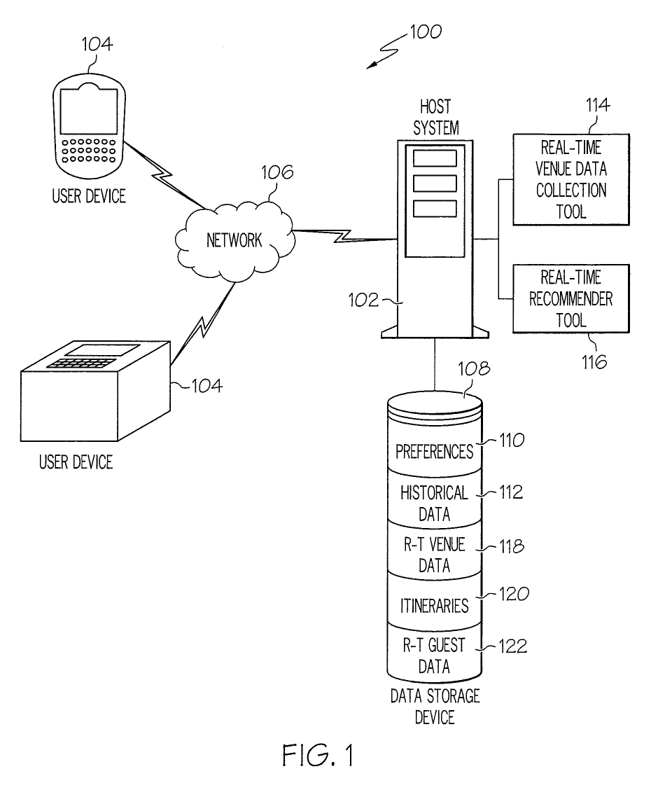

Turning now to the drawings, it will be seen that in FIG. 1 there is a block diagram of a system 100 upon which a real-time recommender tool 116 is implemented in an exemplary embodiment. The system 100 of FIG. 1 includes a host system 102 in communication with user devices 104 over a network 106. The host system 102 may be a data processing device (e.g., a computer), including one or more processors for executing instructions, which handles requests from user devices 104. In an exemplary embodiment, the host system 102 functions as an application server and a data management server for real-time recommendation activities. Each user device 104 may be implemented using a general-purpose computer executing a computer program for carrying out the processes described herein. The user devices 104 may be personal computers (e.g., a lap top, a personal digital assistant, a stationary kiosk) or any handheld device including, but not limited to: cellular telephones, and portable game devices (e.g., using a customized cartridge), etc. This information may be utilized to determine a current geographic location of the guest. Upon a request for suggested future activities (e.g., what attractions to visit) from the guest, the user device 104 may be used to communicate one or more suggested next activities to the guest. If the user device 104 is a kiosk, or other stationary device, then a guest may enter a user-id provided by the venue and/or swipe their radio frequency identification (RFID) encoded ticket to identify themself and to request suggested next activities. The processing described herein may be shared by a user device 104 and the host system 102 (e.g., by providing an applet to the user system 104). The user devices 104 include a user interface for receiving guest preferences and for communicating one or more suggested next activities to the guest. The user interface may be implemented using, but not limited to, a computer screen, a touch screen, a keyboard, a voice response unit, graphics, etc.

While only a single host system 102 is shown in FIG. 1, it will be understood that multiple host systems may be implemented, each in communication with one another via direct coupling or via one or more networks. For example, multiple host systems may be interconnected through a distributed computing architecture. The single host system 102 may also represent a cluster of hosts accessing a common data store, e.g., via a clustered file system that is backed by a data storage device 108. In an alternate exemplary embodiment, the host system 102 is directly user accessible without communication through the network 106, e.g., where the host system 102 is embodied in a desktop computer or workstation.

The network 106 may be any type of communications network known in the art. For example, the network 106 may be an intranet, extranet, or an internetwork, such as the Internet, or a combination thereof. The network 106 can include wireless, wired, or fiber optic links. Further, all or a portion of the network 106 may be implemented by a cellular network, a wireless fidelity network, and/or an infra-red network. Different user devices 104 may be connected to the network 106 in different manners.

The data storage device 108 refers to any type of storage and may comprise one or more secondary storage elements, e.g., a hard disk drive or tape storage system that is external to the host system 102. In an alternate exemplary embodiment, all or a portion of the data storage device 108 is internal to the host system 102 and/or user device(s) 104. Types of data that may be stored in the data storage device 108 include databases and/or files of guest preferences 110, historical data about the venue 112, real-time data about the venue 118, itineraries 120, and real-time data about the guest(s) 122. In an exemplary embodiment, the historical data about the venue 112 and the itineraries 120 for the guests are created by another computer tool (i.e., not the real-time venue data collection tool 114 or the real-time recommender tool 116) and the data is accessed by the real-time recommender tool as input to creating suggested next activities for the guest. In an exemplary embodiment, all of the guest preferences 110 are created by another computer tool. In an alternate exemplary embodiment, guest preferences 110 are augmented by guest input to the real-time recommender tool 116. It will be understood that the data storage device 108 shown in FIG. 1 is provided for purposes of simplification and ease of explanation and is not to be construed as limiting in scope. For example, there may be multiple data storage devices utilized by the host system 102.

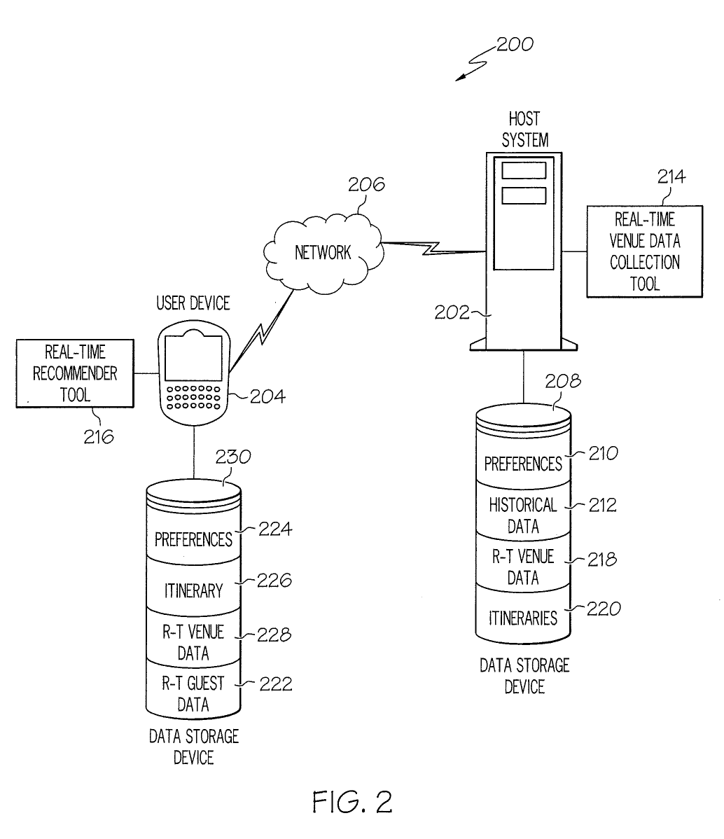

In an exemplary embodiment, the host system 102 executes various applications, including a real-time venue data collection tool 114 and a real-time recommender tool 116. Other applications, e.g., business applications, a web server, etc., may also be implemented by the host system 102 as dictated by the needs of the enterprise of the host system 102. The real-time recommender tool 116 interacts with databases and/or files stored on the data storage device 108. All or a portion of the real-time recommender tool 116 may be located on the user devices 104 with processing shared between the user systems 104 and the host system 102, e.g., a distributed computing architecture. In addition, all or a portion of the data utilized by real-time recommender tool 116 may be located on the user systems 104. See FIG. 2 for an example of a distributed computing architecture that may be implemented by an exemplary embodiment.

In an exemplary embodiment, the user devices 104 access the host system 102 to request real-time recommendations for future activities. The real-time venue data collection tool 114 may connect to other systems and networks, not shown in FIG. 1, to collect real-time data about the venue 118. This information is one of the inputs utilized by the real-time recommender tool 116 to create a real-time recommendation for the guest. The real-time data about the venue 118 is created by various back-end systems and includes items such as, but not limited to: current lines at the activities, the number of tickets left for activities that require tickets, activities that are currently closed, weather, forecast weather, etc. In an exemplary embodiment, the real-time venue data collection tool 114 collects current information about the entire venue 116 and may collect current information about the surrounding area as well as attractions, events and facilities that are outside of the venue.

FIG. 2 is a block diagram of a real-time recommender system that may be implemented by an exemplary embodiment of the present invention. The system 200 in FIG. 2 includes a host 202, a data storage device 208, a real-time venue data collection tool 214, a network 206, a user device 204 and a real-time recommender tool 216. FIG. 2 also includes a data storage device 230 located within, or accessed by the user device 204 for storing data specific to the guest. In the embodiment depicted in FIG. 2, the data storage device 230 includes guest preferences 224, an itinerary 226 and real-time data about the guest 222. The data storage device 208 in communication with the host system 202 stores the itineraries 220 and preferences 210 for all of the guests using the system 200, thus providing a back-up copy for the data stored on the local data storage device 230. This back-up copy may be refreshed every hour or every day or on any other implementation or user defined interval. The itinerary given to one guest may be utilized to generate itineraries for other guests in order to spread guests out at the venue. In addition, recommendations given to the guest via the real-time recommender tool 216 may be uploaded to the data storage device 208. The recommendations given to one guest may be utilized to generate recommendations for other guests in order to spread guests out at the venue.

In addition, the data storage device 230 includes all or a portion of the real-time data about the venue 228 for use by the real-time recommender tool 216. In the system 200 depicted in FIG. 2, the real-time recommender tool 216 is located on the user device 204 along with all or a portion of the data associated with the guest that is requesting suggested next activities at the user device 204. The user device 204 receives all or a portion of the real-time data about the venue 218 from the host system 202 via the network 206. The user device 204 may store all or a portion of this data as real-time data about the venue 228 in the data storage device 230 local to the user device 204.

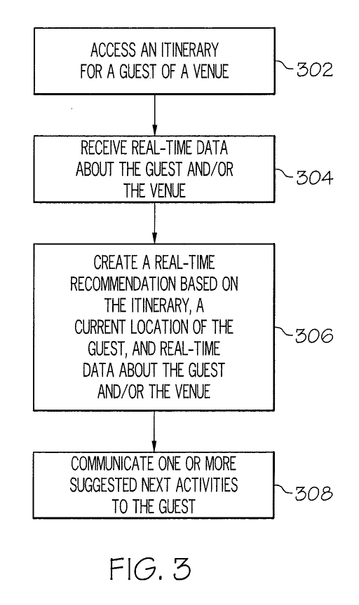

FIG. 3 is a flowchart of an exemplary process for providing a real-time recommender service using the real-time recommender tool described herein. At block 302, an itinerary for a guest of a venue with multiple attractions is accessed. In an exemplary embodiment, the itinerary is accessed in response to a request from the guest for a suggested future activity. In an exemplary embodiment, the itinerary is accessed from a data storage device and was generated based on user preferences and historical data (e.g., past movement of crowds through the venue).

At block 304, one or more of real-time data about the guest and real-time data about the venue is received. The real-time data about the guest may be passively updated by the real-time recommender tool (e.g., by noting that the guest has just visited an activity based on a geographic location of the guest) or actively updated by the guest (e.g., by noting an enjoyment level or other activities visited in the past). The real-time data about the venue, as described previously can include data such as, but not limited to: a current wait time at one or more attractions, an attendance level, and availability of the activities.

At block 306, a real-time recommendation is created based on, among other things, the itinerary, a current geographic location of the guest, and to one or both of the real-time data about the guest and the real-time data about the venue. The real-time recommendation includes one or more suggested future activities for the guest. In this manner, historical data is combined with real-time data to generate one or more suggested future activities for the guest. In addition, the itinerary may be updated based on one or both of the real-time data about the guest and the real-time data about venue, to provide an improved itinerary for later use when the guest requests suggested future activities. In an exemplary embodiment, an additional input to creating the real-time recommendation is the real-time recommendations provided to other guests. Conventional static itineraries and guide books give every guest the same information at the same time. As a result, guest following the itinerary or guide bunch together creating long lines and uneven loads at attractions throughout a venue. When making a real-time recommendation the present invention is able to take into account every other recommendations that have been made to other guests. In this manner, load balancing of crowds across the venue is achieved.

The current geographic location of the guest may be actively determined (e.g., by having the guest entering a current location) or passively determined by providing the guest with a device (same or separate from the user device) that tracks the guest through the venue. In addition, the guest may enter the park with their own device (e.g., a GPS enabled cellular telephone, and a portable game device) that may be utilized to track the guest through the venue in a passive manner. If the user device is a stationary kiosk, then the current geographic location of the guest is the fixed location of the kiosk. In an exemplary embodiment, the geographic location is determined using a GPS.

At block 308, the one or more suggested future activities are communicated to the guest via the user device. As described previously, this communication can be made in a variety of forms, including text, graphics and voice. The real-time recommender tool then waits for the next request from the guest for a real-time recommendation. In an exemplary embodiment, the guest will be reminded of upcoming scheduled events such as dinner reservations. In an exemplary embodiment, the guest requests several activities or types of activities. The real-time recommender tool does not guarantee that the guest will actually do all of the activities requested, nor does the tool allow the guest to dictate the order that these activities will be recommended.

Technical effects include the ability to provide a guest with an improved experience at a venue by taking into account both the preferences of the guest and current conditions of the venue to suggest activities to the guest. By tracking actual crowd movement in the venue, wait times for the guest can be reduced. In addition, the guest receives recommendations that are flexible enough to account for real-time data about the guest. An understanding of the guest preferences as well as the real-timed data about the venue and the guest allows the tool to provide better recommendations to the guest.

As described above, the invention may be embodied in the form of computer-implemented processes and apparatuses for executing those processes. Embodiments of the invention may also be embodied in the form of computer program code containing instructions embodied in tangible media, such as system memory, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic events.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

1. A method for providing real-time recommendations, the method comprising:
accessing an itinerary corresponding to a guest of a venue, the venue having a plurality of attractions and the itinerary created in response to one or more of preferences of the guest and to historical data about the venue;
receiving one or more of real-time data about the guest and real-time data about the venue;
creating a real-time recommendation in response to the itinerary, to a current location of the guest, and to one or more of the real-time data about the guest and the real-time data about the venue, the real-time recommendation including one or more suggested future activities for the guest; and
communicating the one or more suggested future activities to the guest via a user device.

2. The method of claim 1 further comprising updating the itinerary in response to one or more of the real-time data about the guest and the real-time data about the venue.

3. The method of claim 1 wherein the real-time data about the guest includes current preferences of the guest.

4. The method of claim 1 wherein the real-time data about the venue includes a current wait time at one or more attractions at the venue.

5. The method of claim 1 wherein the real-time data about the venue includes one or more of an attendance level and availability of the attractions.

6. The method of claim 1 wherein the real-time data about the venue includes a suggested return time for one or more attractions within the venue.

7. The method of claim 1 wherein the real-time data about the guest includes an estimated current energy level of the guest.

8. The method of claim 1 wherein the historical data about the venue includes data about past movements of crowds through the venue.

9. The method of claim 1 wherein the real-time recommendation is created further in response to itineraries and suggestions given to one or more other guests.

10. The method of claim 1 wherein the preferences of the guest includes one or more of activities the guest is interested in visiting, activities the guest has visited previously, and an enjoyment rating associated with one or more of the activities the guest has visited previously.

11. A system for providing real-time recommendations, the system comprising:
a computer; and
instructions executing on the computer for facilitating:
accessing an itinerary corresponding to a guest of a venue, the venue having a plurality of attractions and the itinerary created in response to one or more of preferences of the guest and to historical data about the venue;
receiving one or more of real-time data about the guest and real-time data about the venue;
creating a real-time recommendation in response to the itinerary, to a current location of the guest, and to one or more of the real-time data about the guest and the real-time data about the venue, the real-time recommendation including one or more suggested future activities for the guest; and
communicating the one or more suggested future activities to the guest.

12. The system of claim 11 wherein the system is mobile and the system further comprises a locator device for determining the current location of the guest.

13. The system of claim 11 wherein the system is stationary with a fixed location and the current location of the guest is the fixed location of the system.

14. The system of claim 11 wherein the real-time data about the venue includes a current wait time at one or more attractions at the venue.

15. The system of claim 11 wherein the real-time recommendation is created further in response to itineraries and suggestions given to one or more other guests.

16. A computer program product for providing real-time recommendations, the computer program product comprising:
a computer-readable storage medium for storing instructions for executing a real-time recommendation service, the real-time recommendation service comprising a method of:
accessing an itinerary corresponding to a guest of a venue, the venue having a plurality of attractions and the itinerary created in response to one or more of preferences of the guest and to historical data about the venue;
receiving one or more of real-time data about the guest and real-time data about the venue;
creating a real-time recommendation in response to the itinerary, to a current location of the guest, and to one or more of the real-time data about the guest and the real-time data about the venue, the real-time recommendation including one or more suggested future activities for the guest; and
communicating the one or more suggested future activities to the guest via a user device.

17. A device for creating a dynamic itinerary for a guest at a venue, the device comprising:
one or more processes executing within the device and operable to access a pre-existing itinerary;
one or more processes executing within the device and operable to access real-time data about the guest;
one or more processes executing within the device and operable to access real-time data about the venue; and
one or more processes executing within the device and operable to modify the preexisting itinerary to create the dynamic itinerary using the real-time data about the guest and the real-time data about the venue.

18. The device of claim 17 further comprising:
one or more processes executing within the device and operable to access real-time data about other guests at the venue, wherein the one or more processes operable to create the dynamic itinerary use the data about other guests at the venue.

19. A crowd management system comprising:
a central system for collecting real-time information about a plurality of guests at a venue and real-time operations data about the venue; and
processes operable to use the collected real-time information and the real-time operations data to generate real-time recommendations for future activities of two or more of the plurality of guests.

20. The system of claim 19 wherein the collected real-time information includes current preferences of one or more of the guests.

21. The system of claim 19 wherein the collected real-time operations data includes a current wait time at one or more of the attractions at the venue.

22. The system of claim 19 wherein the collected real-time operations data includes one or more of an attendance level and availability of the attractions.

23. The system of claim 19 wherein the collected real-time operation data includes a suggested return time for one or more attractions within the venue.

24. The system of claim 19 wherein the processes are further operable to utilize itineraries for two or more of the plurality of guests along with the collected real-time information and the real-time operations data to generate the real-time recommendations for future activities, each itinerary created in response to one or more of preferences of a guest and to historical data about the venue.

25. The system of claim 24 wherein the historical data includes past movements of crowds through the venue.
